(19) United States
(12) Patent Application Publication
(10) Pub. No.: US 2014/0360407 A1
(43) Pub. Date: Dec. 11, 2014

(54) YTTRIUM OXIDE COATING FILM

(71) Applicant: FUJIMI INCORPORATED, Kiyosu-shi, Aichi (JP)

(72) Inventors: Junya Kitamura, Kiyosu-shi (JP); Hiroaki Mizuno, Kiyosu-shi (JP); Filofteia-Laura Toma, Dresden (DE); Stefan Langner, Dresden (DE); Lutz-Michael Berger, Dresden (DE); Annegret Potthoff, Dresden (DE)

(21) Appl. No.: 14/368,455

(22) PCT Filed: Dec. 26, 2012
(86) PCT No.: PCT/JP2012/083542

§ 371 Date: Jun. 24, 2014

(30) Foreign Application Priority Data
Dec. 28, 2011 (JP) 2011-288278

(51) Int. Cl. H01B 3/10; C23C 4/10

(52) U.S. Cl. CPC H01B 3/10; C23C 4/105
USPC 106/286.1; 427/453

(57) ABSTRACT

An yttrium oxide coating has a porosity of 1.5% or less and contains monoclinic yttrium oxide at a ratio of 1% or more and 30% or less to the sum of monoclinic yttrium oxide and cubic yttrium oxide in the coating. The coating is formed, for example, by thermal spraying a thermal spraying material containing yttrium oxide particles and a dispersion medium.

### TECHNICAL FIELD

The present invention relates to an yttrium oxide coating.

### BACKGROUND ART

Yttrium oxide (Y₂O₃) coatings are of high technical value in terms of their high breakdown voltage (unit: kV) and have been used, for example, in applications that require electric insulation (see e.g., Patent Documents 1 and 2).

Increasing coating thickness is an effective means for improving the breakdown voltage of an yttrium oxide coating. In this regard, thermal spraying is advantageous as a method for the formation of an yttrium oxide coating having excellent breakdown voltage because a coating having a large thickness is more easily formed by this method than by a chemical vapor deposition method or electron beam evaporation method. However, a thermally sprayed coating contains a relatively high amount of porosity. Thus, a thermally sprayed coating of yttrium oxide is inferior in electric strength (unit: kV/mm) to chemical vapor deposition coating of yttrium oxide, which has an electric strength of 45 kV/mm (see e.g., Non-Patent Document 1), and to electron beam evaporation coating of yttrium oxide, which has an electric strength of 280 kV/mm (see e.g., Non-Patent Document 2). The yttrium oxide coating, when used in applications that require electric insulation, is needed to have high electric strength as well as high breakdown voltage for reliably preventing the dielectric breakdown of the coating.

In this context, the breakdown voltage of a coating refers to the highest voltage that can be applied to the coating without causing dielectric breakdown. The electric strength of a coating refers to a value that is determined by dividing the breakdown voltage of the coating by the thickness of the coating.

### PRIOR ART DOCUMENTS

Patent Document 1: Japanese Laid-Open Patent Publication No. 2004-211122

Patent Document 2: Japanese Laid-Open Patent Publication No. 2007-291528

Non-Patent Document 1: Development of coating technique of corrosion protection film “yttrium oxide” for vacuum process, [online], November 2009, [retrieved on Dec. 28, 2011], Retrieved from the Internet: <URL: http://www.smrj.go.jp/keiei/dbps_data/_material_/common/chushou/b_keiei/keieitech/pdf/jfetekunorisa-ti5.pdf>

Non-Patent Document 2: C. K. Campbell, “Some dielectric properties of electron-beam evaporated yttrium oxide thin films”, Thin Solid Films, Volume 6, Issue 3, September 1970, pp. 197-202.

### SUMMARY OF THE INVENTION

### Problems that the Invention is to Solve

Thus, an objective of the present invention is to provide an yttrium oxide coating having higher electric strength. Another objective of the present invention is to provide a thermal spraying material that is usable for forming the yttrium oxide coating.

### Means for Solving the Problems

To achieve the foregoing objective and in accordance with one aspect of the present invention, an yttrium oxide coating is provided. The coating has a porosity of 1.5% or less and contains monoclinic yttrium oxide at a ratio of 1% or more and 30% or less to the sum of monoclinic yttrium oxide and cubic yttrium oxide in the coating.

Preferably, the coating has a Vickers hardness of 450 or higher when measured at a load of 2.94 N (300 gf).

Preferably, the coating has an average surface roughness Ra of 2.5 μm or smaller.

Preferably, the coating has an average thickness of 20 μm or larger.

In accordance with another aspect of the present invention, a thermal spraying material is provided that is to be used for forming the yttrium oxide coating according to the above aspect. The thermal spraying material contains yttrium oxide particles and a dispersion medium. The yttrium oxide particles have a volume average particle size of 6 μm or smaller.

In accordance with yet another aspect of the present invention, a thermal spraying material is provided that contains yttrium oxide particles and a dispersion medium. When the thermal spraying material is thermally sprayed by a high-velocity oxygen-fuel spraying method onto a substrate made of aluminum alloy plate that has been sand blasted with a brown alumina abrasive (A#40), a resultant coating on the substrate has a porosity of 1.5% or less. The coating contains monoclinic yttrium oxide at a ratio of 1% or more and 30% or less to the sum of monoclinic yttrium oxide and cubic yttrium oxide in the coating.

### Effects of the Invention

The present invention succeeds in providing an yttrium oxide coating having higher electric strength compared to the conventional thermally sprayed coatings, and at the same time, having low porosity and high mechanical strength. In addition, the present invention succeeds in providing a thermal spraying material usable for forming the yttrium oxide coating.

### MODE FOR CARRYING OUT THE INVENTION

Hereinafter, one embodiment of the present invention will be described.

An yttrium oxide (Y₂O₃) coating according to the present embodiment is obtained by thermal-spraying of a thermal spraying material. The thermal spraying is performed onto a substrate. Thus, the coating is provided on the substrate. The substrate may be made of metal, such as aluminum, titanium, iron, and an alloy containing these metals, or ceramic, such as alumina and yttria. The thermal spraying material may be in a powder or slurry (or suspension) form.

The powder thermal spraying material for forming the coating comprises yttrium oxide particles, suitable in size for processing. Yttrium oxide particles preferably form 100% of the powder thermal spraying material.

The slurry thermal spraying material is prepared by mixing yttrium oxide particles, suitable in size, with a dispersion medium, such as water and alcohol, including ethanol, preferably water. The slurry thermal spraying material may contain a small amount of an organic dispersing agent, such as polyvinyl alcohol. Yttrium oxide particles are not necessarily the main component of the slurry thermal spraying material. Dispersion medium and organic dispersing agent are evaporated or oxidized during the thermal spray process, which results in no or less inclusion in the coating.

The slurry thermal spraying material has a slurry concentration, i.e., a solid content, of preferably 10% by mass or higher, more preferably 15% by mass or higher, further preferably 20% by mass or higher, and particularly preferably 30% by mass or higher. The coating is formed more efficiently from slurry thermal spraying material having a higher slurry concentration.

The solid content in the slurry thermal spraying material is also preferably 70% by mass or lower, more preferably 60% by mass or lower, and further preferably 50% by mass or lower. Slurry thermal spraying material having a lower slurry concentration is more stable when supplied to a thermal spraying machine.

The yttrium oxide particles used for coating preparation may contain inevitable impurities such as iron, cobalt, nickel, chromium, sodium, potassium, calcium, and magnesium. However, for obtaining a coating having higher electric strength, it is preferable that the yttrium oxide particles should be as highly pure as possible. Specifically, the yttrium oxide particles have an yttrium oxide content, i.e., purity of the yttrium oxide particles, of preferably 98% by mass or higher, more preferably 99% by mass or higher, and further preferably 99.9% by mass or higher. It is preferable that the yttrium oxide particles should contain metal impurities such as iron, cobalt, nickel, and chromium in as small amounts as possible because these metal impurities are responsible for reduced electric strength of the coating. The total content of iron, cobalt, nickel, and chromium as the metal impurities is preferably 200 ppm or lower, more preferably 100 ppm or lower, and further preferably 50 ppm or lower. For the same reason, it is also preferable that the content of sodium, potassium, calcium, or magnesium should be as small as possible. The total content of sodium and potassium is preferably 200 ppm or lower, more preferably 100 ppm or lower, and further preferably 50 ppm or lower. The total content of calcium and magnesium is preferably 200 ppm or lower, more preferably 100 ppm or lower, and further preferably 50 ppm or lower. The content of impurities contained in the yttrium oxide particles can be measured by inductively coupled plasma mass spectrometry (ICP-MS) or atomic absorption spectrometry.

The yttrium oxide particles used for coating preparation from slurry thermal spraying material have an average particle size (volume average particle size) of preferably 6 μm or smaller, more preferably 4 μm or smaller, further preferably 2 μm or smaller, and much more preferably 1.5 μm or smaller. A more densely structured coating is obtained from a thermal spraying material containing yttrium oxide particles having a smaller average particle size. The measurement of the average particle size of the yttrium oxide particles can be performed in accordance with methods such as laser diffraction scattering, BET, and light scattering. The average particle size of the yttrium oxide particles can be measured, in accordance with laser diffraction scattering, for instance by using a laser diffraction/scattering-type particle size measuring instrument “LA-300” manufactured by Horiba Ltd.

The thermal spraying material may be thermally sprayed by a high-velocity flame spraying (e.g., high-velocity oxygen-fuel spraying (HVOF) or high-velocity air-fuel spraying (HVAF)) or atmospheric-pressure plasma spraying (APS) method. For obtaining a more densely structured coating, it is preferred to use high-velocity flame spraying. A fuel used in the high-velocity flame spraying may be a hydrocarbon gas fuel (e.g., acetylene, ethylene, propane, or propylene) or a liquid fuel such as kerosene or ethanol. However, the hydrocarbon gas fuel is preferable because a higher flame temperature is obtained.

The yttrium oxide coating has an yttrium oxide content of preferably 98% by mass or higher, more preferably 99% by mass or higher, and further preferably 99.9% by mass or higher. A coating having a higher yttrium oxide content has higher electric strength.

The coating is required to have a porosity of 1.5% or less and preferably has a porosity of 1.2% or less, more preferably 1% or less, further preferably 0.8% or less, and particularly preferably 0.6% or less. A coating having a lower porosity has higher electric strength. A coating having a lower porosity is also advantageous in that connected open pores are less likely to form in the coating. The presence of connected open pores in the coating is disadvantageous because these pores will generate formation of local heating micro-zones where the high electrical field densities concentrate resulting in critical failure paths and consequently the coating will show dielectric breakdown.

When yttrium oxide particles having an average particle size of 6 μm or smaller is thermally sprayed onto a substrate, the yttrium oxide particles are quenched and consolidated on the substrate to thereby form monoclinic yttrium oxide in the surface part of each yttrium oxide particle and cubic yttrium oxide in the central part of each yttrium oxide particle. Therefore, the yttrium oxide in the obtained coating contains at least two phases of monoclinic and cubic crystals. The monoclinic yttrium oxide formed in the surface part of each yttrium oxide particle has the function to enhance the strength of bonding among the yttrium oxide particles.

In order to enhance the joint strength of bonding among the yttrium oxide particles by the function of monoclinic yttrium oxide, the coating is required to contain monoclinic yttrium oxide at a ratio of 1% or more to the sum of monoclinic yttrium oxide and cubic yttrium oxide and preferably contains 5% or more, more preferably 8% or more, and further preferably 10% or more monoclinic yttrium oxide. In contrast, in order to ensure a sufficient amount of cubic yttrium oxide having higher breakdown voltage and mechanical strength than those of monoclinic yttrium oxide, the coating is also required to have monoclinic yttrium oxide at a ratio of 30% or less to the sum of monoclinic yttrium oxide and cubic yttrium oxide and preferably contains 25% or less, and more preferably 20% or less monoclinic yttrium oxide. Thus, with the ratio maintained within the above range, the coating has favorable electric strength and mechanical strength.

The ratio of monoclinic yttrium oxide to the sum of monoclinic yttrium oxide and cubic yttrium oxide in the coating is determined according to the formula: Pm (%)=[Im/(Im+Ic)]×100, wherein Pm represents the ratio of monoclinic yttrium oxide to the sum of monoclinic yttrium oxide and cubic yttrium oxide in the coating; Im represents the peak intensity of monoclinic yttrium oxide (402) in the X-ray diffraction pattern of the coating; and Ic represents the peak intensity of cubic yttrium oxide (222) in the X-ray diffraction pattern of the coating.

The cubic yttrium oxide in the coating has a crystallite size of preferably 80 nm or smaller, and more preferably 60 nm or smaller. A coating having a smaller crystallite size of the cubic yttrium oxide has a higher grain boundary density, resulting in higher mechanical properties, for example, higher hardness. The crystallite size of the cubic yttrium oxide in the coating is determined from the half-width of a cubic yttrium oxide (222) peak in the X-ray diffraction pattern, using the Scherrer's equation.

The monoclinic yttrium oxide in the coating has a crystallite size of preferably 60 nm or smaller, and more preferably 50 nm or smaller. A coating having a smaller crystallite size of the monoclinic yttrium oxide has a higher grain boundary density, resulting in higher mechanical properties, for example, higher hardness. The crystallite size of monoclinic yttrium oxide in the coating is determined from the half-width of a monoclinic yttrium oxide (402) peak in the X-ray diffraction pattern, using the Scherrer's equation.

The coating has specific resistance of preferably 1×10¹¹ Ωcm or higher, and more preferably 5×10¹¹ Ωcm or higher, and further preferably 1×10¹² Ωcm or higher. A coating having higher specific resistance reduces leakage current value during voltage application.

When measured at a load of 2.94 N (300 gf), the coating has a Vickers hardness of preferably 450 or higher, more preferably 500 or higher, and further preferably 530 or higher. A coating having a higher Vickers hardness has higher electric strength.

The coating has an average surface roughness Ra of preferably 2.5 μm or lower, and more preferably 2 μm or lower. A coating having a lower average surface roughness Ra is advantageous because a better electrical contact between the electrode(s) and coating is provided during dielectric measurements. A densely structured coating having a low porosity tends to have a low average surface roughness Ra.

The coating has a standard deviation o of preferably 0.5 μm or smaller, and more preferably 0.4 μm or smaller, in surface roughness. A coating having a smaller standard deviation of the surface roughness has more uniform electric strength throughout the coating.

The coating has an average thickness of preferably 20 μm or larger, more preferably 50 μm or larger, further preferably 100 μm or larger, and much more preferably 150 μm or larger. A coating having a larger average thickness has higher breakdown voltage.

It is preferable that the coating does not have a variation in thickness greater than plus or minus 10%.

The coating has a breakdown voltage of preferably 2.5 kV or higher, more preferably 3.5 kV or higher, and further preferably 4 kV or higher.

The present embodiment produces the following advantage:

The yttrium oxide coating according to the present embodiment contains monoclinic yttrium oxide at a ratio of 1% or more and 30% or less to the sum of monoclinic yttrium oxide and cubic yttrium oxide. Thus, high electric strength is advantageously secured because the coating has a porosity as low as 1.5% or less. Therefore, a coating having high electric strength is provided.

The embodiment described above may be modified as follows:

The yttrium oxide coating may be formed not only by thermal-spraying a thermal spraying material containing yttrium oxide particles but by an approach other than thermal spraying, for example, chemical vapor deposition (CVD), physical vapor deposition (PVD), or aerosol deposition.

Next, the present invention will be described more specifically with reference to Examples and Comparative Examples.

In Examples 1 to 5 and Comparative Example 1, yttrium oxide particles prepared by calcination were mixed with water to prepare a thermal spraying material in a slurry form, which was then thermally sprayed onto a substrate under conditions shown in Table 1 to thereby form thereon a coating having a thickness of 150 μm.

In Comparative Examples 2 to 4, a thermal spraying material in a powder form consisting of yttrium oxide particles or aluminum oxide particles was prepared by agglomeration and sintering and thermally sprayed onto a substrate under conditions shown in Table 2 or 3 to form thereon a coating having a thickness of 150 μm. As a result, the coating was successfully formed in Comparative Examples 3 and 4, whereas Comparative Example 2 failed to form the coating.

All the substrates used in these Examples and Comparative Examples were plates of 50 mm×75 mm×5 mm in size made of an aluminum alloy (A6061) and used after being sand blasted in advance with a brown alumina abrasive (A#40).

TABLE 1
High-velocity oxygen fuel spraying conditions
(Examples 1 to 5 and Comparative Example 1)

Thermal spraying machine high-velocity flame
spraying machine “TopGun”, manufactured by GTV
Verschleiβschutz GmbH
Suspension feeder unit: pressure reservoir
Oxygen flow rate: 180 L/min
Ethylene flow rate: 60 L/min
Thermal spraying distance: 90 mm
Suspension feed rate: 60 mL/min

TABLE 2
High-velocity oxygen fuel spraying conditions (Comparative Example 2)

Thermal spraying machine: high-velocity flame spraying machine
“JP-5000”, manufactured by Praxair
TAFA Inc.
Powder feeder unit: “AM30”, manufactured by Technoserve Co., Ltd.
Oxygen flow rate: 1,900 scfh (893 L/min)
Kerosene flow rate: 5.1 gph (0.32 L/min)
Thermal spraying distance: 380 mm
Barrel length of thermal spraying machine: 203.2 mm
Thermal spray powder feed rate: 70 g/min

TABLE 3
Atmospheric-pressure plasma spraying conditions
(Comparative Examples 3 and 4)

Thermal spraying machine: “SG-100”, manufactured by
Praxair Surface Technologies Inc.
Powder feeder: “AM30”, manufactured by Technoserve Co., Ltd.
Ar gas pressure: 50 psi (0.34 MPa)
He gas pressure: 50 psi (0.34 MPa)
Voltage: 37.0 V
Current: 900 A
Thermal spraying distance: 120 mm
Thermal spray powder feed rate: 20 g/min

Details about the thermal spraying materials used in Examples 1 to 5 and Comparative Examples 1 to 4 and about the coatings obtained from the thermal spraying materials are shown in Table 4.

The column entitled “Particle type” in Table 4 shows the types of ceramic particles used to prepare the respective thermal spraying materials of Examples 1 to 5 and Comparative Examples 1 to 4. “Y₂O₃” in this column indicates that yttrium oxide particles were used, and “Al₂O₃” indicates that aluminum oxide particles were used.

The column entitled “Particle purity” in Table 4 shows the purity of ceramic particles, i.e., a ceramic content of ceramic particles, used in each of Examples 1 to 5 and Comparative Examples 1 to 4. “3N” in this column indicates a purity of 99.9%, and “4N” indicates a purity of 99.99%.

The column entitled “Average particle size” in Table 4 shows the average particle size (volume average particle size) of ceramic particles used in each of Examples 1 to 5 and Comparative Examples 1 to 4.

The column entitled “Form of thermal spraying material” in Table 4 shows the form of the thermal spraying material prepared in each of Examples 1 to 5 and Comparative Examples 1 to 4. “Slurry” in this column indicates that a thermal spraying material in a slurry form was prepared, and “Powder” indicates that a thermal spraying material in a powder form was prepared.

The column entitled “Slurry concentration” in Table 4 shows a solid content of the thermal spraying material in slurry form prepared in each of Examples 1 to 5 and Comparative Example 1 with respect to the total mass of the thermal spraying material.

The column entitled “Coating formation method” in Table 4 shows a method used to form a coating using the thermal spraying material in each of Examples 1 to 5 and Comparative Examples 1 to 4. “HVOF” in this column indicates that high-velocity oxygen fuel spraying was used, and “Plasma” indicates that atmospheric-pressure plasma spraying was used.

The column entitled “Porosity” in Table 4 shows results of measuring the porosity of the coating obtained in each of Examples 1 to 5 and Comparative Examples 1, 3 and 4. The porosity was measured by image analysis using the cross section of the coating mirror-polished with colloidal silica having an average particle size of 0.06 μm.

The column entitled “Ratio of monoclinic crystals” in Table 4 shows results of determining, according to the formula described above, the ratio of monoclinic yttrium oxide to the sum of monoclinic yttrium oxide and cubic yttrium oxide in the yttrium oxide coating obtained in each of Examples 1 to 5 and Comparative Examples 1 and 3.

The column entitled “Crystallite size of cubic yttrium oxide” in Table 4 shows results of determining the crystallite size of cubic yttrium oxide from the half-width of a cubic yttrium oxide (222) peak in the X-ray diffraction pattern of the yttrium oxide coating obtained in each of Examples 1 to 5 and Comparative Examples 1 and 3.

The column entitled “Crystallite size of monoclinic yttrium oxide” in Table 4 shows results of determining the crystallite size of monoclinic yttrium oxide from the half-width of a monoclinic yttrium oxide (402) peak in the X-ray diffraction pattern of the yttrium oxide coating obtained in each of Examples 1 to 5 and Comparative Examples 1 and 3.

The column entitled “Specific resistance” in Table 4 shows results of measuring the specific resistance of the coating obtained in each of Examples 1 to 5 and Comparative Examples 1, 3 and 4. In this measurement, a resistivity meter Hiresta UP model MCP-HT450 manufactured by Mitsubishi Chemical Analytech Co., Ltd. was used. The measurement conditions included an applied voltage of 1 kV and time of application of 60 seconds. As a counter electrode, a URS probe was used.

The column entitled “Vickers hardness” in Table 4 shows results of measuring the Vickers hardness of the coating obtained in each of Examples 1 to 5 and Comparative Examples 1, 3 and 4. The values were obtained by applying load of 2.94 N (300 gf) to the cross section of the obtained coating using an indenter. In this measurement, a micro hardness tester HMV-1 manufactured by Shimadzu Corp. was used.

The columns entitled “Average surface roughness” and “Standard deviation of surface roughness” in Table 4 show results of measuring the average surface roughness Ra and standard deviation o thereof, of the coating obtained in each of Examples 1 to 5 and Comparative Examples 1, 3 and 4. In this measurement, a probe-type surface roughness meter was used.

The column entitled “Breakdown voltage” in Table 4 shows results of measuring the breakdown voltage of the coating obtained in each of Examples 1 to 5 and Comparative Examples 1, 3 and 4. This measurement was conducted according to the method described in Japanese Industrial Standards (JIS) C2110-1 corresponding to International Electrotechnical Commission (IEC) 60243. Specifically, a withstanding voltage/insulation resistance tester TOS9201 manufactured by Kikusui Electronics

Corporation was used at a temperature of 20° C. and a relative humidity of 50%. The measurement conditions included a voltage sweep speed of 200 V/second. A brass cylinder having a diameter of 25 mm was used as a counter electrode.

The column entitled “Electric strength” in Table 4 shows results of measuring the electric strength of the coating obtained in each of Examples 1 to 5 and Comparative Examples 1, 3 and 4. This measurement was conducted according to the method described in JIS C2110-1 corresponding to IEC 60243.More specifically, the electric strength was obtained by dividing the breakdown voltage of each coating, which was measured in the above method, by the thickness of the coating.

TABLE 4

| | | | Average | Form of | | |
|---|---|---|---|---|---|---|
| | | | particle | thermal | Slurry | Coating |
| | Particle | Particle | size | spraying | concentration | formation |
| | type | purity | [μm] | material | [% by mass] | method |
| Example 1 | Y₂O₃ | 3N | 6 | Slurry | 30 | HVOF |
| Comparative | Y₂O₃ | 3N | 8 | Slurry | 30 | HVOF |
| Example 1 | | | | | | |
| Comparative | Y₂O₃ | 3N | 15 | Powder | — | HVOF |
| Example 2 | | | | | | |
| Comparative | Y₂O₃ | 3N | 15 | Powder | — | Plasma |
| Example 3 | | | | | | |
| Example 2 | Y₂O₃ | 3N | 2 | Slurry | 30 | HVOF |
| Example 3 | Y₂O₃ | 3N | 0.6 | Slurry | 30 | HVOF |
| Example 4 | Y₂O₃ | 3N | 0.06 | Slurry | 30 | HVOF |
| Example 5 | Y₂O₃ | 3N | 2 | Slurry | 50 | HVOF |
| Comparative | Al₂O₃ | 4N | 15 | Powder | — | Plasma |
| Example 4 | | | | | | |

| | | | | | | | | Standard | | |
|---|---|---|---|---|---|---|---|---|---|---|
| | | | | Crystallite | | | | deviation | | |
| | | | Crystallite | size of | | | Average | of | | |
| | | Ratio of | size of | monoclinic | Specific | Vickers | surface | surface | Breakdown | Electric |
| | Porosity | monoclinic | cubic yttrium | yttrium oxide | resistance | hardness | roughness | roughness | voltage | strength |
| | [%] | crystals [%] | oxide [nm] | [nm] | [Ω cm] | (Hv 0.3) | [μm] | [μm] | [kV] | [kV/mm] |
| Example 1 | 1.0 | 1.2 | 75 | 35 | 2 × 10¹¹ | 460 | 2.3 | 0.5 | 2.7 | 18 |
| Comparative | 1.4 | <0.1 | 85 | Unmeasurable | 8 × 10¹⁰ | 420 | 2.7 | 0.5 | 2.1 | 14 |
| Example 1 | | | | | | | | | | |
| Comparative | — | — | — | — | — | — | — | — | — | — |
| Example 2 | | | | | | | | | | |
| Comparative | 1.9 | 0.5 | 90 | Unmeasurable | 1 × 10¹¹ | 450 | 3.1 | 0.8 | 2.0 | 13 |
| Example 3 | | | | | | | | | | |
| Example 2 | 0.8 | 2 | 65 | 29 | 5 × 10¹² | 500 | 1.9 | 0.4 | 3.6 | 24 |
| Example 3 | 0.4 | 15 | 48 | 23 | 3 × 10¹³ | 550 | 1.7 | 0.3 | 4.4 | 29 |
| Example 4 | 0.7 | 25 | 40 | 20 | 2 × 10¹² | 540 | 1.8 | 0.3 | 4.1 | 27 |
| Example 5 | 1.4 | 8 | 70 | 32 | 9 × 10¹¹ | 460 | 2.1 | 0.4 | 2.9 | 19 |
| Comparative | 2.1 | — | — | — | 5 × 10¹² | 1100 | 3.4 | 0.9 | 1.8 | 11 |
| Example 4 | | | | | | | | | | |

As shown in Table 4, the coatings obtained in Examples 1 to 5 had an electric strength of 15 kV/mm or higher, which was a practically satisfactory level. By contrast, the coatings obtained in Comparative Examples 1, 3 and 4 had an electric strength lower than 15 kV/mm, which was not a practically satisfactory level.

1. An yttrium oxide coating, wherein
the coating has a porosity of 1.5% or less, and
the coating contains monoclinic yttrium oxide at a ratio of 1% or more and 30% or less to the sum of monoclinic yttrium oxide and cubic yttrium oxide in the coating.

2. The coating according to claim 1, wherein the coating has a Vickers hardness of 450 or higher when measured at a load of 2.94 N.

3. The coating according to claim 1, wherein the coating has an average surface roughness Ra of 2.5 μm or smaller.

4. The coating according to claim 1, wherein the coating has an average thickness of 20 μm or larger.

5. A thermal spraying material to be used for forming the coating according to claim 1, comprising yttrium oxide particles and a dispersion medium, wherein the yttrium oxide particles have a volume average particle size of 6 μm or smaller.

6. A thermal spraying material comprising yttrium oxide particles and a dispersion medium, wherein
when the thermal spraying material is thermally sprayed by a high-velocity oxygen-fuel spraying method onto a substrate made of aluminum alloy plate that has been sand blasted with a brown alumina abrasive (A#40), a resultant coating on the substrate has a porosity of 1.5% or less, and
the coating contains monoclinic yttrium oxide at a ratio of 1% or more and 30% or less to the sum of monoclinic yttrium oxide and cubic yttrium oxide in the coating.

7. The thermal spraying material according to claim 5, wherein the yttrium oxide particles are contained in the thermal spraying material in an amount of 30% by mass or higher.

8. The thermal spraying material according to claim 6, wherein the yttrium oxide particles are contained in the thermal spraying material in an amount of 30% by mass or higher.

9. A method of forming an yttrium oxide coating, comprising:
preparing the thermal spraying material according to claim 5; and
thermal-spraying the prepared thermal spraying material to form an yttrium oxide coating, wherein the coating has a porosity of 1.5% or less, and the coating contains monoclinic yttrium oxide at a ratio of 1% or more and 30% or less to the sum of monoclinic, yttrium oxide and cubic yttrium oxide in the coating.

10. The method according to claim 9, wherein the yttrium oxide particles are contained in the thermal spraying material in an amount of 30% by mass or higher.
